(19) United States
(12) Patent Application Publication
(10) Pub. No.: US 2007/0246057 A1
(43) Pub. Date: Oct. 25, 2007

(54) EAR TREATMENT FOR EXCESS HAIR

(76) Inventor: Sigfrid A. Muller, Las Vegas, NV (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/738,089

(22) Filed: Apr. 20, 2007

Related U.S. Application Data
(60) Provisional application No. 60/794,253, filed on Apr. 20, 2006.

(51) Int. Cl. A61Q 7/02

(52) U.S. Cl. 132/202; 424/70.1

(57) ABSTRACT

The topical use of eflornithine hydrochloride on an ear to reduce or retard the growth of ear hair. Eflornithine hydrochloride is applied to an area of ear hair growth until the hair growth decreases to a desired level. Eflornithine hydrochloride may then be applied at a decreased frequency in order to maintain the desired level of hair growth.

### PRIORITY CLAIM

The present application claims priority to co-pending provisional application Ser. No. 60/794,253, entitled EAR TREATMENT FOR EXCESS HAIR, filed on Apr. 20, 2006, the contents of which is incorporated by reference in its entirety herein.

### FIELD

Embodiments of the present invention relate to the reduction and prevention of hair growth. Particularly, embodiments relate to the reduction and prevention of ear hair growth using a topical solution.

### BACKGROUND

Hairy ears is a problem that has been afflicting elderly men for years. As men age hair growth from the lower ears increases in number and in thickness. To combat the ear hair progression, trimming ear hair becomes a necessary bimonthly event. Between trimmings, the ear hair continues to grow.

The problem of ear hair is common among men as they age. Unfortunately, not much is known about the cause of hair growth or how to prevent it. Excessive hair growth is referred to as hypertrichosis. Most geneticists speculate that hairy ears are an inherited trait passed along on the Y (male) chromosome. In men, hairy ears are very common. In one study, 74 percent of elderly men had hairy ears.

### SUMMARY

Embodiments of the present invention disclose the use of eflornithine hydrochloride to reduce or retard the growth of ear hair. The eflornithine hydrochloride may be used topically in or on the skin of the ears to reduce or prevent ear hair growth and to prevent the recurrence of ear hair growth.

### BRIEF DESCRIPTION OF THE DRAWINGS

FIG. 1 is a flow chart demonstrating the treatment of excess ear hair using eflornithine hydrochloride.

### DESCRIPTION

The following discussion is presented to enable a person skilled in the art to make and use embodiments of the invention. Various modifications to the illustrated embodiments will be readily apparent to those skilled in the art, and the generic principles herein may be applied to other embodiments and applications without departing from embodiments of the invention. Thus, embodiments of the invention are not intended to be limited to embodiments shown, but are to be accorded the widest scope consistent with the principles and features disclosed herein. The selected embodiments disclosed are not intended to limit the scope of the invention. Skilled artisans will recognize the examples provided herein have many useful alternatives and fall within the scope of embodiments of the invention. The following introductory material is intended to familiarize the reader with the general nature and some of the features of embodiments of the invention.

The inventor has found the use of topical eflornithine hydrochloride cream, applied directly to the hairy ears, is helpful in the retardation of hair growth in and around the ears. Eflornithine hydrochloride cream is available by prescription as Vaniqa and is commercially offered by SkinMedica, Inc. of Carlsbad Calif.

Vaniqa is currently a prescription cream approved by the Food and Drug Administration to reduce the growth of unwanted facial hair in women. Vaniqa is an eflornithine cream used as a specific irreversible inhibitor of the enzyme ornithine decarboxylase, which is used for the production of polyamines, compounds required for cell division. Vaniqa is believed to inhibit the enzyme ornithine decarboxylase in the hair follicles. Percutaneous absorption in women when 15% cream was applied twice daily to a shaved 50 cm² area of skin under the chin was less than 1% and excreted unmetabolized. The onset of improvement according to the package insert for the product was seen in as little as four to eight weeks of treatment. The condition may return to pretreatment levels eight weeks after discontinuance of the treatment.

Although Vaniqa is known to reduce unwanted facial hair in women, such hair is believed to be different from the unwanted ear hair which grows in men. The higher levels of testosterone present in men may be expected to make men's hair more resistant to treatment in comparison to the hair of women, which is present in a lower testosterone environment. In addition, the unwanted ear hair of men tends to be thicker and denser than unwanted facial hair in women, which might also be expected to make ear hair more resistant to treatment.

Despite the differences between unwanted facial hair in women and ear hair in men, the inventor has discovered that eflornithine hydrochloride is effective in decreasing ear hair in men and that it may even be more effective in reducing ear hair in men than it is in reducing facial hair in women. In one example, the use of Vaniqa on the skin of the ears resulted in mildly decreased ear hair growth after three weeks of treatment. After six weeks of treatment, a noticeably decreased ear hair growth was noted with almost complete inhibition of hair growth after 10 weeks of continued application of the Vaniqa cream. The inventor has also discovered that the hair retardation can be maintained by nightly applications possibly only two or three times a week.

In most men, the auricular hairs are localized, dense, and aesthetically unpleasant. The hair bulbs at these sites are close to the surface with little associated subcutaneous tissue, so that sufficient concentration of Vaniqa is believed to reach the hair bulbs at these sites.

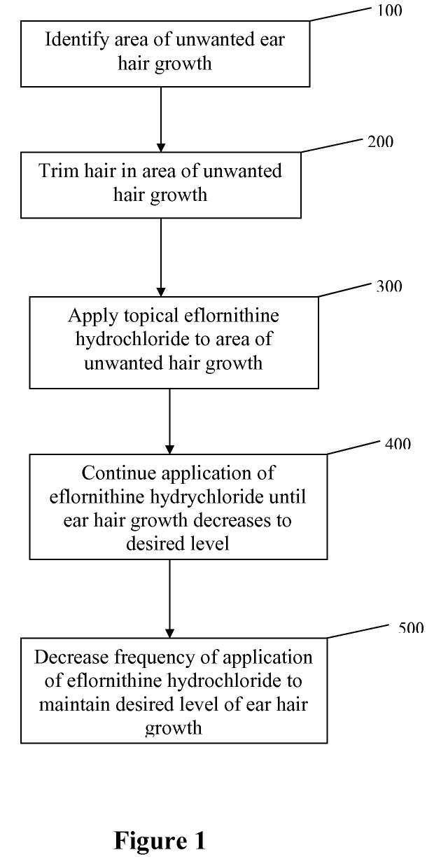

The growth of ear hair may be reduced or nearly eliminated as shown in FIG. 1. First, an area of unwanted ear hair growth is identified 100. This area may be in or on the ear. The area may be in or on the lower ears, such as below the tragus/antitragus. The hair in this area may then be trimmed 200. Topical eflornithine hydrochloride is then applied to the area 300. The topical eflornithine hydrochloride may be in the form of a cream, such as a 13.9% Vaniqa cream. An appropriate dose is a 3 to 4 millimeter droplet. The application of eflornithine hydrochloride cream is continued until ear hair growth decreases to a desired level 400. Once the desired level of hair growth is achieved, the eflornithine hydrochloride is applied at a decreased frequency to maintain the desired level of hair growth 500. For example, the eflornithine hydrochloride may be applied once per day for maintenance. Alternatively, maintenance may be achieved by applying the eflornithine hydrochloride 2 to 3 times per week.

### EXAMPLE

Disclosed below is one example of the use of eflornithine hydrochloride cream to address the issue of ear hair growth. The patient was a 75 year old man with an approximately 12 year history of ear hair. His general health was satisfactory and he was working full-time in a busy dermatological practice. Hair growth from the lower ears was noted about 12 years ago in increasing numbers in thickness, and especially so for the past six or seven years. Trimming ear hair became a necessary bimonthly event and trips to the barber shop were highlighted by the especially close trim provided by the barber.

One year previously, the patient had a one centimeter mixed tumor of the left parotid gland excised. The excision required cutting the left great auricular nerve causing permanent numbness of the left ear and surrounding skin. Six months later, it was clearly evident that the hair growth on the denervated left ear was significantly greater and thicker than in the right ear.

Upon examination, the patient was a healthy appearing man with Fitzpatrick skin type III with thick terminal hairs densely growing from the pinnas localized to the area below the tragus/antitragus, like a cholla cactus bush, especially on the left (according to the patient). The numbness of the left auricular and surrounding skin was significantly less than in the postoperative period after the left partial parotidectomy one year ago.

A last trimming of ear hairs was done. Treatment with eflornithine hydrochloride cream 13.9% (Vaniqa) was begun six days later. The eflornithine cream was applied directly to hairy skin areas of the lower ears (about a 3-4 mm droplet of cream at each site).

Mildly decreased hair growth was noted after three weeks of treatment, but less so in the left ear.

After six weeks of treatment, a noticeably decreased hair growth was confirmed by the nurses with almost complete inhibition of hair growth after 10 weeks of continued application of the Vaniqa cream. The near complete inhibition of hair growth was been maintained for one month by only nightly applications of the eflornithine cream. Consideration has been given to a maintenance schedule of applying the cream only two or two to three times a week.

From this example it can be shown that eflornithine hydrochloride can be effectively used to retard the growth of ear hair in men, to nearly completely inhibit hair growth and to maintain ear hair growth at a decreased level.

The use of Vaniqa on the skin of the ears has been further evaluated in other individuals. An additional 25 male patients with unwanted ear hair applied Vaniqa to the area of unwanted ear hair as described in the previous example. In all cases, the use of Vaniqa resulted in reduced ear hair growth. It was further observed that completely discontinuing the use of Vaniqa resulted in the recurrence of ear hair growth to pretreatment levels after 8 weeks. However, when treatment with Vaniqa was resumed, ear hair growth decreased again.

Thus, embodiments of the treatment of excess ear hair are disclosed. One skilled in the art will appreciate that the present invention can be practiced with embodiments other than those disclosed. The disclosed embodiments are presented for purposes of illustration and not limitation, and the present invention is limited only by the claims that follow.

I claim:

1. A method of reducing hair growth in the ears, comprising:
applying topical eflornithine hydrochloride to an area of hair growth on or within an ear until hair growth decreases; and
continuing to apply the eflornithine hydrochloride until ear hair growth decreases to a desired level.

2. The method of claim 1, wherein applying topical eflornithine hydrochloride comprises applying a 3-4 mm droplet.

3. The method of claim 1, wherein the eflornithine hydrochloride has a concentration of 13.9%.

4. The method of claim 1, wherein the eflornithine hydrochloride is applied at multiple areas of hair growth on or within the ear until hair growth decreases at the multiple areas.

5. The method of claim 1, further comprising:
once the desired level of ear hair has been achieved, applying the topical eflornithine hydrochloride to the area at a decreased frequency.

6. The method of claim 5, wherein the decreased frequency is once per day.

7. The method of claim 5, wherein the decreased frequency is 2 to 3 times per week.

8. The method of claim 1, further comprising trimming existing ear hair prior to the first application of eflornithine hydrochloride.

9. The method of claim 1, wherein the ear comprises a tragus and an antitragus and wherein the area of hair growth is below the tragus and antitragus.

10. The method of claim 1, wherein the area of hair growth is denervated.

11. The method of claim 1, wherein the topical eflornithine hydrochloride comprises a cream.

12. A method of reducing hair growth in the ears of a human male patient, comprising:
applying topical eflornithine hydrochloride to an area of hair growth on or within an ear, the eflornithine hydrochloride being applied at a first frequency of applications per week; and
applying topical eflornithine hydrochloride to the area of hair growth on or within the ear, the eflornithine hydrochloride being applied at a second frequency of applications per week after being applied at the first frequency of applications per week, the second frequency being less than the first frequency.

13. The method of claim 12, wherein the eflornithine hydrochloride is applied at the first frequency for up to 10 weeks.

14. The method of claim 12, wherein the second frequency is two or three applications per week.

15. The method of claim 12, wherein the areas of hair growth have hair bulbs close to the ear surface with little associated subcutaneous tissue.

16. The method of claim 12, wherein the eflornithine hydrochloride has a concentration of 13.9%.

17. The method of claim 12, further comprising trimming existing ear hair prior to the first application of eflormithine hydrochloride.

18. The method of claim 12, wherein applying topical eflornithine hydrochloride comprises applying a 3-4 mm droplet.

19. A method of maintaining reduced ear hair growth on the ears of a human male patient, comprising:
applying topical eflornithine hydrochloride to an area of hair growth on or within an ear, the eflornithine hydrochloride being applied at a frequency of multiple times per week, the eflornithine hydrochloride having a concentration of approximately 13.9%.
